(19) United States
(12) Patent Application Publication
(10) Pub. No.: US 2025/0354754 A1
(43) Pub. Date: Nov. 20, 2025

(54) GRAIN-SAMPLE COLLECTION FOR MOISTURE TESTING

(71) Applicant: John MCKAY, Knapp, WI (US)

(72) Inventor: John MCKAY, Knapp, WI (US)

(21) Appl. No.: 19/080,030

(22) Filed: Mar. 14, 2025

Related U.S. Application Data
(60) Provisional application No. 63/648,619, filed on May 16, 2024.

(51) Int. Cl. F26B 21/08; G01N 1/20

(52) U.S. Cl. CPC F26B 21/08; G01N 1/2035; F26B 2200/06; G01N 2001/2014; G01N 2001/205

(57) ABSTRACT

A system configured to collect a representative sample of dried grain from an industrial grain dryer to inform the dryer's automatic temperature controller includes: a plurality of drop tubes each having a top end and a bottom end, wherein the top end of each drop tube is communicatively coupled to a respective dump chute of the grain dryer and configured to receive a respective partial grain sample from the dump chute; connective tubing communicatively coupling the bottom ends of the plurality of drop tubes; an air blower communicatively coupled to a proximal end of the connective tubing, wherein the air blower is configured to propel the partial grain samples distally through the connective tubing; and a collection box communicatively coupled to a distal end of the connective tubing, wherein the collection box is configured to receive and aggregate the partial grain samples into a combined sample for moisture testing.

### TECHNICAL FIELD

The present technology is generally related to agriculture, and in particular, to industrial dryers to dehydrate crops for long-term storage,

### BACKGROUND

Shortly after harvesting a grain crop—such as corn, soybeans, or wheat—farmers use an industrial grain dryer to dehydrate the crop for long-term storage. The grain dryer burns fuel, such as propane or natural gas, to blow a stream of hot, dry air to evaporate the moisture retained within the grain. One common design is called a “top-dry” or “roof-dry” grain dryer, which includes an upper drying chamber positioned over a lower storage bin. Once the grain is sufficiently dehydrated in the upper chamber, it is released downward through dump chutes into the storage bin below and allowed to cool. After dehydration and cooling, the grain may be stored virtually indefinitely without decomposing or growing mold.

### SUMMARY OF THE DISCLOSURE

The techniques of this disclosure generally relate to industrial-scale grain dryers. More specifically, the present disclosure describes systems and methods for strategically collecting representative samples of dried grain in order to compensate for local variances in moisture content at the end of a drying sample.

In a first example, a grain-sampler system includes system configured to collect a sample of dried grain from an industrial grain dryer to inform the dryer's temperature controller, wherein the system includes: a plurality of drop tubes each having a top end and a bottom end, wherein the top end of each drop tube is communicatively coupled to a respective dump chute of the grain dryer and configured to receive a respective grain sample from the dump chute; connective tubing communicatively coupling the bottom ends of the plurality of drop tubes; an air blower communicatively coupled to a proximal end of the connective tubing, wherein the air blower is configured to propel the grain samples distally through the connective tubing; and a receptacle communicatively coupled to a distal end of the connective tubing, wherein the receptacle is configured to receive and aggregate the grain samples into a combined sample for subsequent moisture testing of the combined sample.

The details of one or more aspects of the disclosure are set forth in the accompanying drawings and the description below. Other features, objects, and advantages of the techniques described in this disclosure will be apparent from the description and the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1A is a perspective view of an example dried-grain-sample-collection system installed within a roof-based industrial grain dryer, in accordance with the techniques of this disclosure.

FIG. 1B is a side-profile view of the sample-collection system of FIG. 1A.

FIG. 1C is a top view or overhead view of the sample-collection system of FIGS. 1A & 1B.

FIG. 2A is an overhead view of a proximal portion of the sample-collection system of FIGS. 1A-1C.

FIG. 2B is a side-profile view of the proximal portion of the sample-collection system shown in FIG. 2A.

FIG. 2C is an overhead view of a distal portion of the sample-collection system of FIGS. 1A-1C.

FIG. 2D is a side-profile view of the distal portion of the sample-collection system shown in FIG. 2C.

FIG. 3 shows an example implementation of an air blower for the sample-collection system of FIGS. 1A-1C.

FIG. 4A is a right-front perspective view of an example implementation of a sample-collection box for the sample-collection system of FIGS. 1A-1C.

FIG. 4B is a rear perspective view of the sample-collection box of FIG. 4A.

FIG. 4C is a left-front perspective view of the sample-collection box of FIGS. 4A & 4B.

FIG. 4D is a back view or rear view of the sample-collection box of FIGS. 4A-4C. FIG. 4E is a right-side-profile view of the sample-collection box of FIGS. 4A-4D.

FIG. 4F is a bottom view or underside view of the sample-collection box of FIGS. 4A-4E.

FIG. 4G shows another example implementation of the sample-collection box of FIGS. 4A-4F installed within an industrial grain dryer, with a front panel in a “closed” position.

FIG. 4H shows the sample-collection box of FIG. 4G with its front panel in an “open” position.

FIG. 5 shows an example implementation of a grain-sample-moisture tester for the sample-collection system of FIGS. 1A-1C, as coupled to the exterior housing of an industrial grain dryer.

FIG. 6A is a front perspective view of an example drop tube for the sample-collection system of FIGS. 1A-1C, including a one-way check valve and a valve-actuator tube.

FIG. 6B is a perspective view of an example one-way flipper for the check valve of FIG. 6A.

FIG. 7A is a front perspective view of another example drop tube for the sample-collection system of FIGS. 1A-1C, including a one-way check valve.

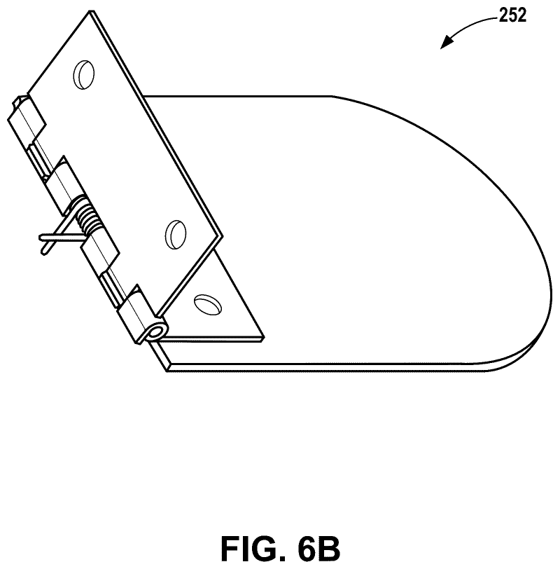

FIG. 7B is a closeup transparent view of the one-way check valve of FIG. 7A while in a “closed” configuration.

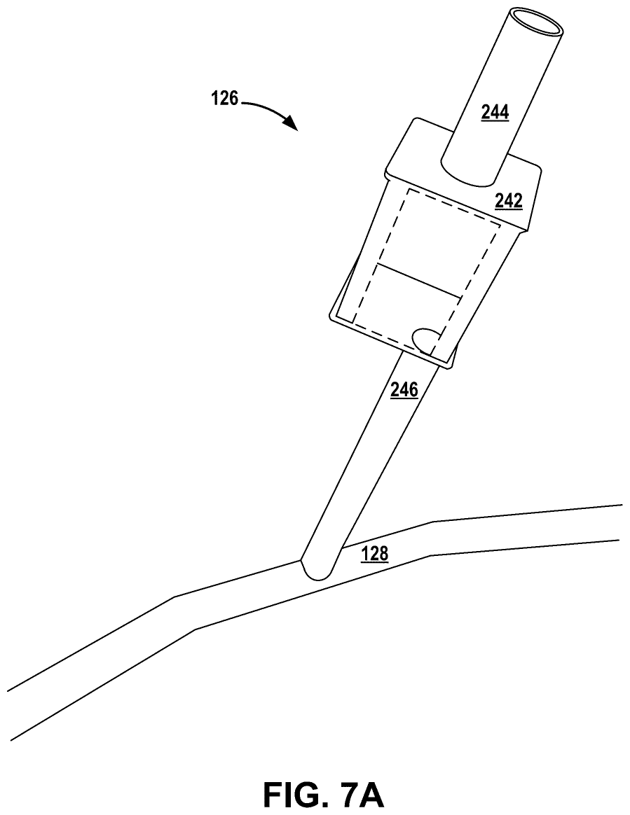

FIC. 7C is a closeup transparent view of the one-way check valve of FIGS. 7A & 7B while in an “open” configuration.

FIG. 8 shows an example valve-actuator tube for the drop tube of FIGS. 6A & 7A.

FIG. 9A is a perspective view of an example implementation of a standpipe for the drop tube of FIGS. 6A & 7A.

FIG. 9B is a rear view of the standpipe of FIG. 9A.

FIG. 9C is a side-profile view of the standpipe of FIGS. 9A & 9B.

FIG. 9D is a bottom view or underside view of the standpipe of FIGS. 9A-9C.

FIG. 9E shows an example implementation of the standpipe of FIGS. 9A-9D coupled to a dump chute of an industrial grain dryer.

FIG. 10A shows a portion of another example implementation of the sample-collection system of FIGS. 1A-1C installed within a 24-foot-diameter roof-based industrial grain dryer.

FIG. 10B shows another portion of the sample-collection system of FIG. 10A.

FIG. 10C shows a portion of a drop tube of the sample-collection system of FIGS. 10A and 10B.

FIG. 11 shows an example control panel for a temperature controller of the industrial grain dryer of FIGS. 1A-1C.

FIG. 12 is a conceptual diagram illustrating, from an overhead-view perspective, how the sample-collection system of FIGS. 1A-1C can be installed within three different sizes of industrial grain dryers.

FIG. 13 is a flowchart illustrating an example method for collecting a highly representative sample of dried grain from a roof-type industrial grain dryer.

While examples of this disclosure are amenable to various modifications and alternative forms, specifics thereof shown by way of example in the drawings will be described in detail. It should be understood, however, that the intention is not to limit the disclosure to the particular examples described.

### DETAILED DESCRIPTION

Shortly after harvesting a crop of corn, wheat, soybeans, or other grain, farmers use an industrial-sized grain dryer to dehydrate the crop for long-term storage. Many modern grain dryers are “roof”-type dryers, having an upper drying chamber positioned over a lower storage bin. Two such models include the “TopDry” Roof Dryer, manufactured by GSI (formerly “Grain Systems, Inc.”) of Assumption, Illinois; and the “EasyDry” Batch Dryer, manufactured by AGI Westeel of Alberta, Canada.

Typical roof-based grain dryers include a heater that burns a supply of fuel, such as propane or natural gas, to heat a supply of air up to a “plenum” temperature of about 180° F. to about 230° F. The heater then blows the hot, dry air through the upper drying chamber to evaporate moisture stored within the grain crop. During each drying cycle, the batch of grain is heated for either a predetermined time duration (e.g., 20 minutes), or until a probe thermometer within the drying chamber measures a predetermined “trigger” temperature (e.g., typically around 130° F. to 140° F.), which then deactivates the heater and triggers an array of “dump chutes” to drop downward to dump the current batch of dried grain into the storage bin below.

The roof-type design is advantageous in that the residual heat rising upward from the dried grain in the storage bin is partially “recycled,” as it helps dehydrate the subsequent batch of grain in the drying chamber above. After dehydration and cooling, the dry grain can be stored virtually indefinitely without decomposing or growing mold—that is, as long as the moisture content remains at or below a certain threshold value, generally accepted to be about 15% by weight.

Unfortunately, users have recently identified a fundamental flaw within the operations of many current systems. Specifically, a number of different factors have been identified that can cause the “local” grain temperature—measured by any one of the probe thermometer(s)—to fluctuate drastically from the average temperature of the batch of dried grain overall. This discrepancy means that the heater frequently runs much longer, or much shorter, than is actually necessary to dry the grain down to the “ideal” moisture content of about 15%. Clearly, under-drying the grain poses a risk of losing some or all of the crop to spoilage, e.g., mold or other sources of undesirable decomposition.

While over-drying the grain reduces instances of spoilage, the additional savings in healthy sellable product is actually offset by the additional cost of wasted fuel that has been burned to dehydrate the grain more than is actually necessary. For instance, over-drying the grain from 15% moisture down to 13% moisture typically costs an additional 2 cents per bushel, as well as additional losses to dehydration-related shrinkage when packaged by volume. One metric even indicates that over-drying losses may be exponential—the cost of over-drying the grain from 15% moisture down to 12% could be as high as 5 cents per bushel. As an illustrative example, a farmer who typically dries around 250,000 bushels of corn each season could be spending an additional $12,500 on wasted fuel.

Despite ongoing suspicions that the probe thermometers are relatively poor indicators of the actual moisture content of the batch of grain for a particular drying cycle, the author of the present disclosure is the first to both identify and compensate for individual sources of “localized” temperature fluctuations within each batch of grain.

For instance, when the dump chutes temporarily drop down at the end of a drying cycle to release the batch of grain into the storage bin, the grains that drop down during the first five seconds of the dump duration (e.g., 30 seconds) can be discernably dryer than grains falling during the final five seconds of the dump duration, because the “later” grains were partially insulated from the hot-air supply by the “earlier” grains sitting beneath them.

As another example, probe thermometer(s) positioned closer to the output from the heater are likely to measure a higher average grain temperature (i.e., a lower average moisture content, as low as 12%), while thermometer(s) farther away from the heater might simultaneously measure a lower grain temperature (i.e., a higher moisture content, up to about 18%).

Ideally, after the individual dried grains are combined together in the storage bin, the overall moisture content typically averages out to the “target” moisture level of about 15%. Unfortunately, the numerous sources of localized temperature fluctuations end up triggering the dumping cycle, and thus, are propagated forward into the average moisture content of the larger batch, resulting in the economic losses described above.

Accordingly, the present disclosure is directed to systems and associated techniques for collecting highly “representative” samples of dried grain—i.e., that significantly reduce or eliminate multiple known sources of local fluctuations in temperature—to drastically increase the reliability of moisture testing, the results of which are used to run the grain dryer within an optimal range. In fact, the techniques of this disclosure can be used to drive an automatic “feedback loop” that runs the grain dryer more-and-more efficiently over time. That is, the output from a highly-representative moisture-content measurement can be fed back into the grain dryer to automatically adjust the subsequent drying cycle, e.g., by adjusting the heater duration, the probe-thermometer-trigger temperature, or, in rare cases, the plenum temperature of the heater. In this way, the present systems and techniques are able to strike a precise, delicate balance between the cost of conserved fuel (which would otherwise be burned to excessively dehydrate the crop) and the cost of preserved crop (which would otherwise be lost to moisture-induced spoilage).

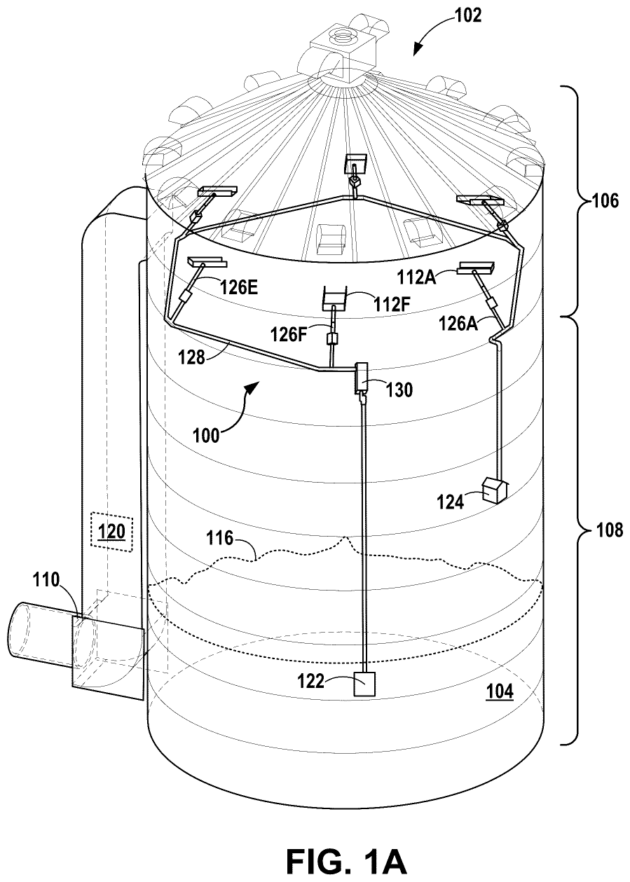

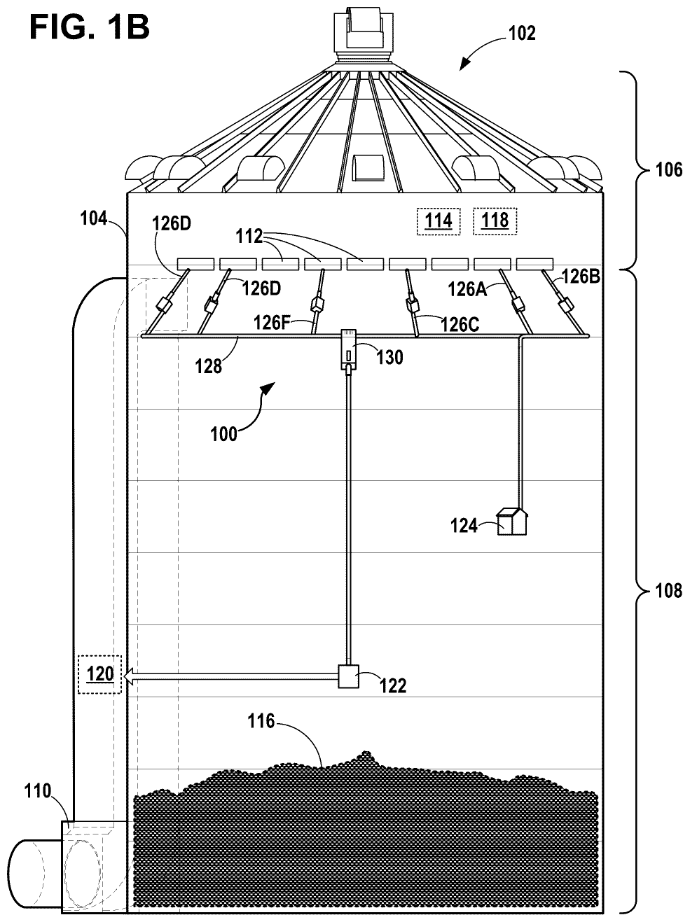

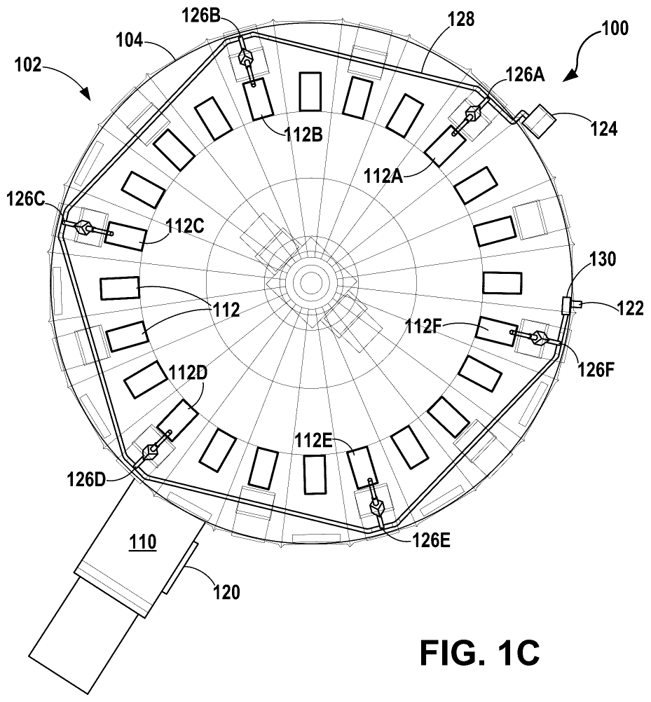

For instance, FIGS. 1A-1C illustrate an example grain-sample collection system 100 (hereinafter, “sample collector 100”) installed within a roof-based industrial grain dryer 102. As described above, roof dryer 102 includes a cylindrical housing 104 defining an upper drying chamber 106 and a large storage bin 108, as well as a heater 110 and a plurality of dump chutes 112 spaced evenly around the circumference of the housing 104. In the illustrative (i.e., non- limiting) example shown in FIGS. 1A-1C, the roof dryer 102 is depicted as having a 24-foot-diameter housing 104, and twenty-four dump chutes 112 spaced evenly around the circumference of the housing 104. Other examples of grain dryers may have more than twenty-four dump chutes or fewer than twenty-four dump chutes.

During each drying cycle, the heater 110 blows hot air into the upper drying chamber 106 until an “end” condition is met-either the expiration of a predetermined drying-cycle time duration (e.g., 20 minutes), or a predetermined threshold temperature (e.g., 200° F.) measured by a thermometer 114 within the drying chamber 106. The “end” condition causes the grain dryer 102 to automatically lower the dump chutes 112 for a predetermined duration (e.g., 30 seconds), thereby releasing the bottom-most ⅓ to ¼ of the dried grain 116 downward into the storage bin 108 for cooling and long-term storage. When partially-dry grain that remains in the upper chamber 106 shifts downward to replace the fully-dry grain 116 as it empties through the dump chutes 112, a fill switch 118 is uncovered, which causes the dryer 102 to automatically refill the upper chamber 106 with more fresh grain until the switch 118 becomes fully covered again.

As referenced above, roof dryer 102 includes a partially automated control system 120 configured to dynamically adjust condition(s) of the subsequent drying cycle based on a measured value of the moisture content of the immediately preceding batch of dried grain 116, as indicated by a moisture tester 122 (e.g., another thermometer). In accordance with the techniques of this disclosure, sample collector 100 is configured to extract a highly representative sample from a batch of dried grain 116 after a drying cycle, in order for the moisture tester 122 to output an accurate measurement of the batch's moisture content. In general, sample collector 100 includes: an air blower 124, plurality of drop tubes 126A-126F (collectively, “drop tubes 126”) coupled to the dump chutes 112, a nearly-circular length of connective tubing 128, and a collection box 130.

In some examples of sample collector 100, the system is configured as a distinct, “retrofittable” system, i.e., configured to be assembled within a previously constructed industrial grain dryer 102. In other examples, sample collector 100 can be installed concurrently with the manufacture of a “new” grain dryer. In some such examples, the sample collector 100 may be considered to be “fully integrated” or “integrally formed” with the dryer, i.e., not intended to be non-destructively removable or separable from the dryer.

In accordance with the techniques of this disclosure, sample collector 100 is configured to collect a “partial” grain sample from each of a plurality of dump chutes 112A-112F at different positions around the inner circumference of the dryer's housing 104. Sample collector 100 is further configured to merge the individual samples together into a “combined” sample prior to testing the moisture content, thereby averaging-out any local variations in their respective moisture contents. For an illustrative example, as shown best in FIG. 1C, dump chute 112D (bottom left) is located immediately adjacent to the output from the heater 110, whereas dump chute 112A (upper right) is much farther away. Accordingly, collecting a partial grain sample from both locations is critical for obtaining an accurate measurement of the moisture content for the batch of grain as a whole.

Under this preferred principle of spatial distribution of partial-grain-sample sources, the sample collector 100 can be configured to collect a partial sample from any suitable subset of two or more dump chutes 112—up to, and including, all of dump chutes 112. For instance, sample collector 100 can include drop tubes 126 coupled to approximately ¼ of the total number of dump chutes 112. This example ratio of drop-tubes-to-dump-chutes is depicted in FIG. 1C, in which drop tubes 126A-126F are connected to six of the twenty-four dump chutes 112A-112F. In preferred examples, the six pairs of dump chutes 112 and drop tubes 126 are evenly spaced or distributed around the inner circumference of the dryer housing 104, i.e., as opposed to being closely grouped together within a common “wedge” of the housing's circular cross-sectional area.

In addition to diversifying the circumferential locations from which the partial grain samples are sourced, as detailed further below, the drop tubes 126 of sample collector 100 are uniquely designed to extract a constant “trickle” of grain, i.e., over an extended period of time, rather than an “instantaneous” extraction from the dump chutes 112. In this way, sample collector 100 compensates for any potential moisture-content fluctuations across both space and time, thereby increasing the representative “accuracy” of the combined sample, in some cases by a vast margin.

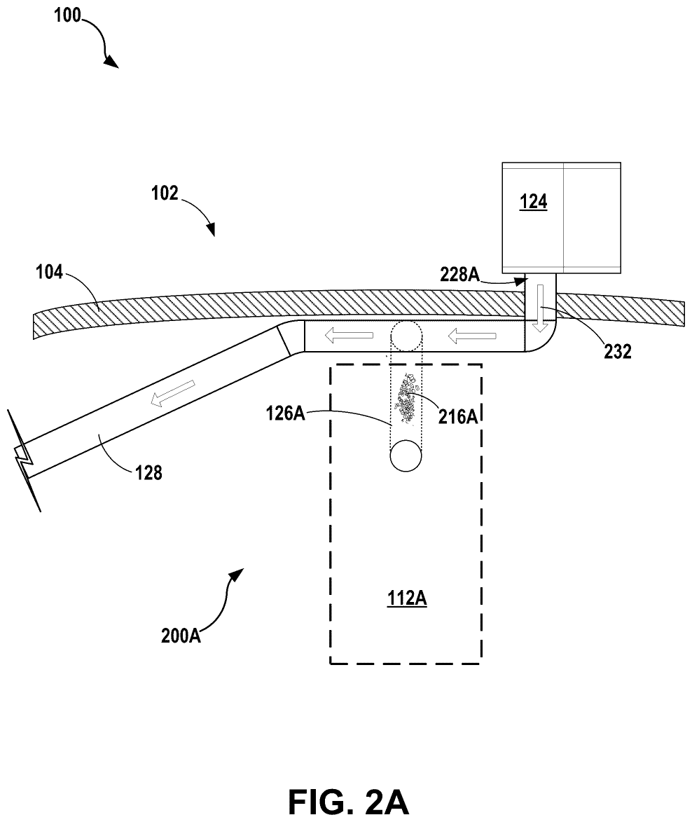

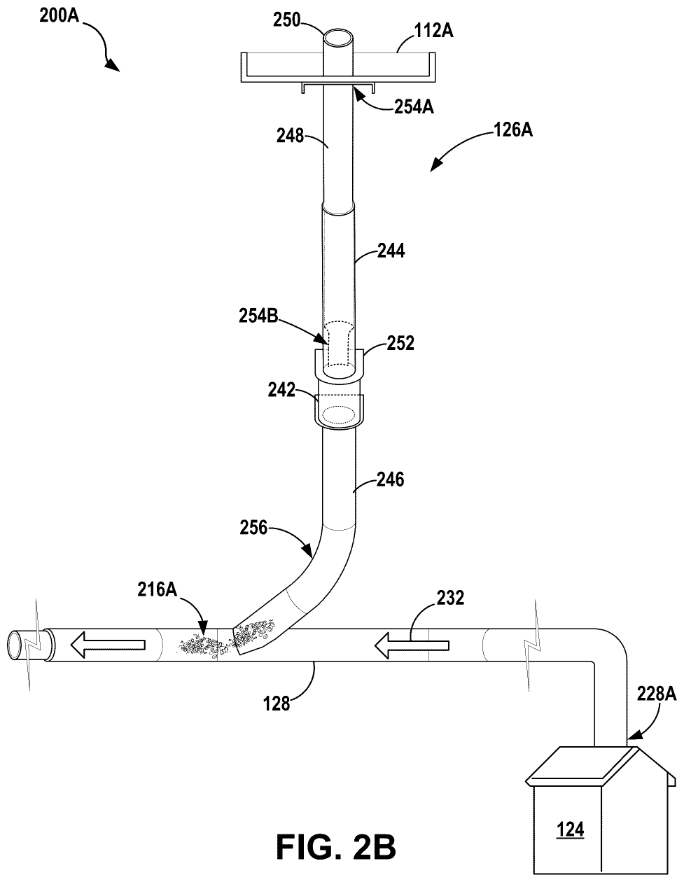

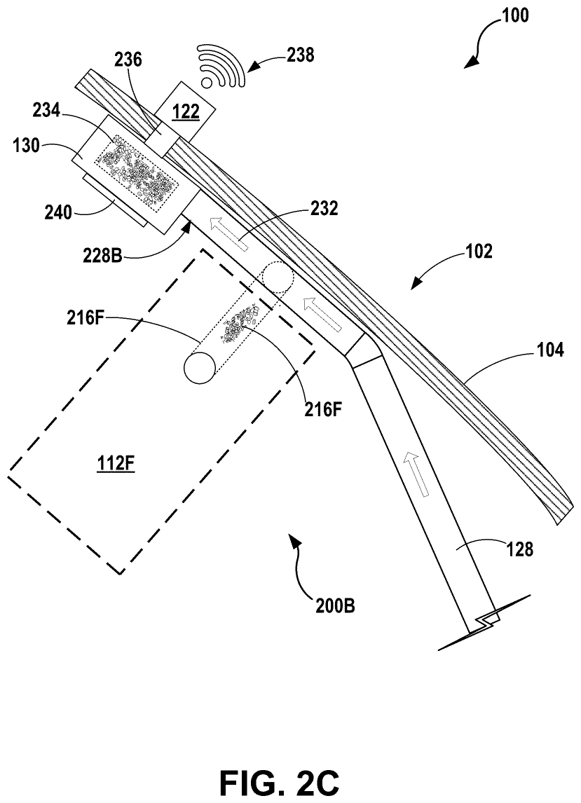

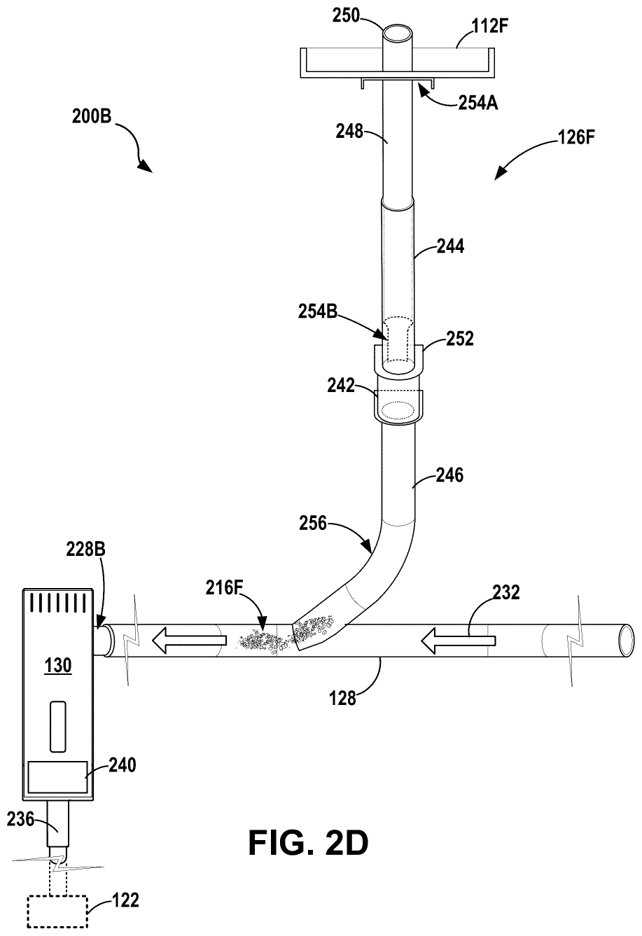

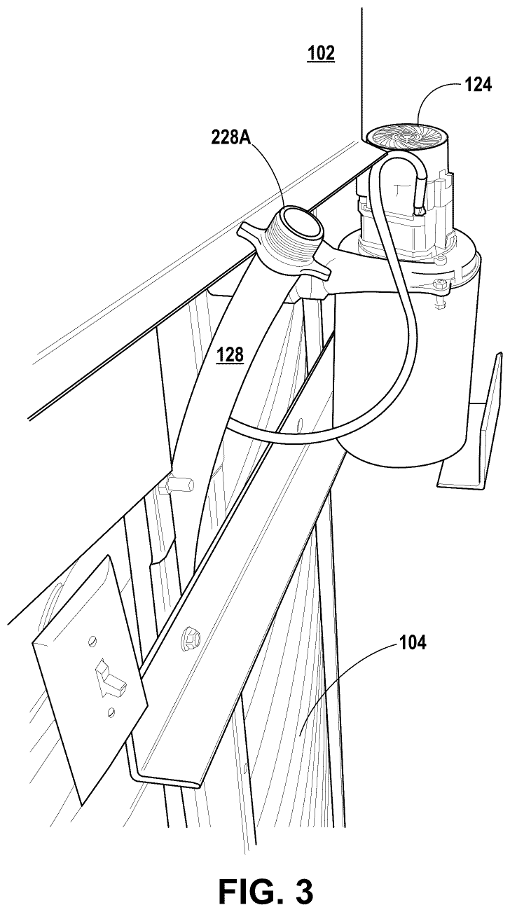

FIGS. 2A and 2B are closeup views of a “proximal” portion (or “beginning” portion) 200A of sample collector 100; FIGS. 2C and 2D are closeup views of a “distal” portion (or “end” portion) 200B of sample collector 100. Within the proximal portion 200A, sample collector 100 includes an air blower 124, such as a fan driven by an electric motor (e.g., as in the example implementation shown in FIG. 3).

The motor of the air blower 124, along with the the dump chutes 112, is communicatively coupled to the probe thermometer 114; the fan of the air blower is fluidically coupled to a proximal end 228A of the connective tubing 128. When the probe thermometer 114 detects the predetermined “trigger” temperature, it outputs a signal that causes the dump chutes 112 to drop downward to release the dried grain 116 into the storage bin 108. Meanwhile, partial grain samples 216 begin to fall from the dump chutes 112, through the drop tubes 126, and down into the length of connective tubing 128 at the bottom.

The same signal output from the probe thermometer 114 is also received by the air blower 124, which triggers a pair of time-delayed circuits. As one illustrative example, if the dump chutes are configured to drop down for a duration of 30 seconds, then the first-time delay circuit can be configured for a 45-second countdown, and the second time-delay circuit can be configured for a 60-second countdown.

Thus, 15 seconds after the dump chutes 112 raise back upward again, thereby sealing the check valves of the drop tubes 126 (detailed further below), the first time-delay circuit causes the electric motor of the air blower 124 to activate the air blower's fan. The resulting air current 232 produced by the air blower 124 propels the partial grain samples 216 distally through the connective tubing 128 toward a common end location, i.e., the distal end 228B of connective tubing 128, until the second time-delay circuit deactivates the fan 15 seconds later.

Within the distal portion 200B (FIGS. 2C and 2D), the sample collector 100 includes a grain-sample collection box 130. The collection box 130 is fluidically coupled to the distal end 228B of the connective tubing 128, in order to receive all of the partial grain samples 216A-216F and merge them into a combined grain sample 234 that is highly representative of the moisture content of the entire batch of dried grain 116. This combined sample 234 is particularly suited for high-accuracy moisture testing. Accordingly, as seen in FIGS. 2C and 2D, the collection box 130 is functionally coupled to an automatic moisture tester 122 configured to rapidly “read” the moisture content of the combined grain sample 234. For instance, the collection box 130 can include an extension 236 configured to extend through the dryer housing 104 and couple to a moisture tester 122 affixed to the exterior of the dryer housing 104. Additionally or alternatively, a moisture tester 122 can be fixed inside collection box 130, or can be integrally formed with collection box 130 as a common functional unit.

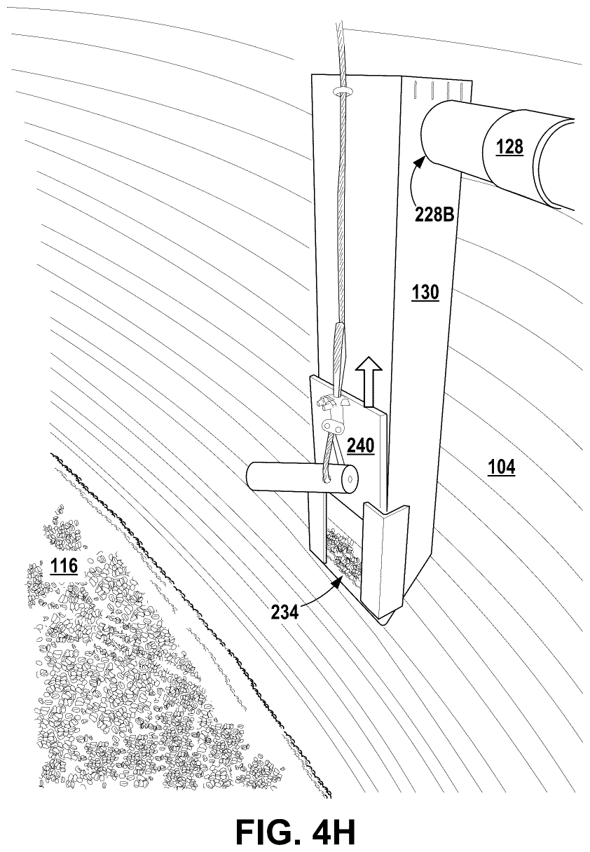

The moisture tester 122 generates a measurement of the moisture content (or temperature, as a proxy) of the combined grain sample 234, and outputs a signal 238 indicative of the measurement. The moisture-measurement signal 238 is transmitted back to the controller 120 to inform the controller 118 whether to modify the subsequent drying cycle, as described above. For instance, the moisture signal 238 can be or can include a wireless signal, as indicated in FIG. 2C. Additionally or alternatively, the moisture signal 238 can be or can include an electrical signal transmitted via a conductive wire between the moisture tester 122 and temperature controller 120 (as indicated in FIG. 5). Additionally or alternatively, the moisture signal 238 can be or can include an optical signal transmitted via a fiber-optic cable between moisture tester 122 and the temperature controller 120.

In some examples, and as detailed further below, the sample collector 100 further includes means for conveniently collecting the combined grain sample 234 from the collection box 130 and/or the moisture tester 122, e.g., after the moisture measurement is complete. The combined sample 234 can then be transported to a secondary location for additional moisture testing or other analysis, as desired by the user. For instance, the combined sample 234 can periodically be collected from the moisture tester 122 and transported to a secondary moisture tester (not shown) that is more precise but slower than the primary tester 120, e.g., to help calibrate the primary moisture tester 120 and/or to confirm the results of the primary moisture tester 120.

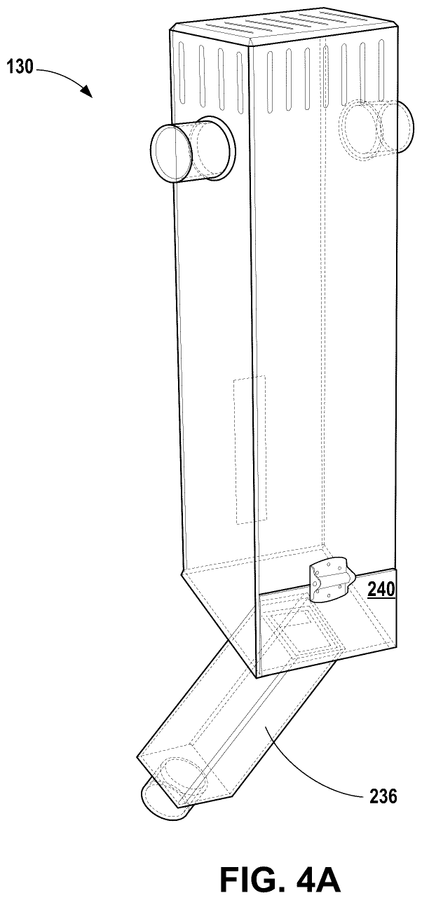

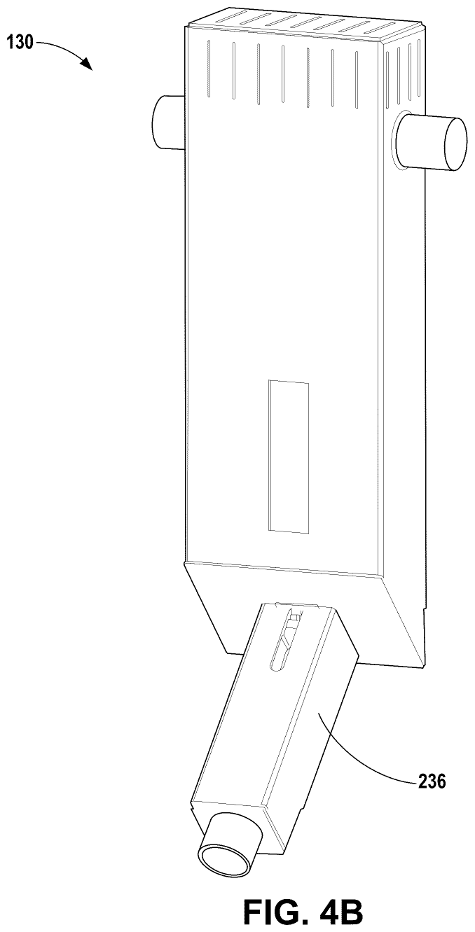

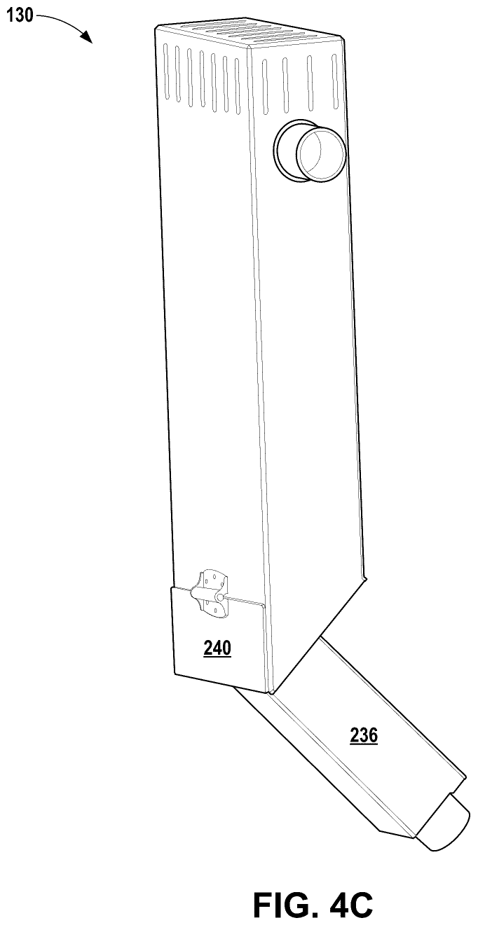

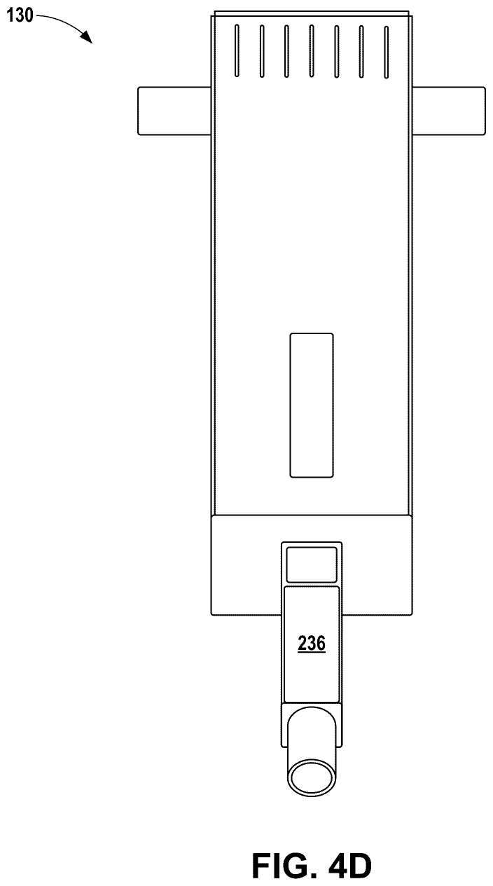

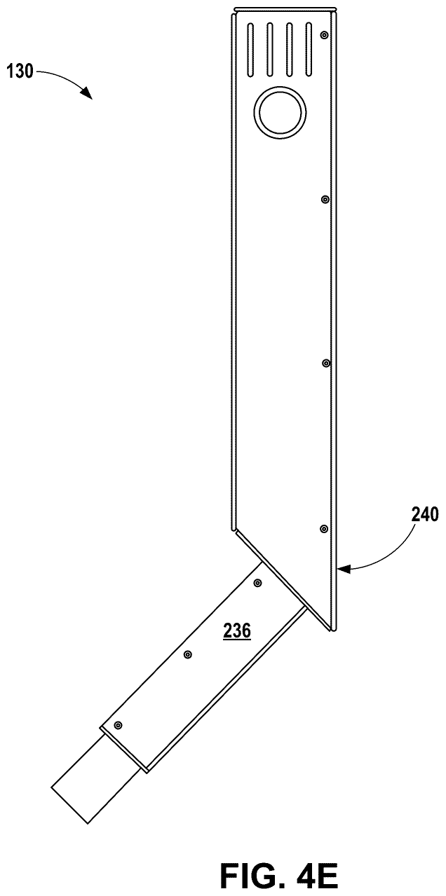

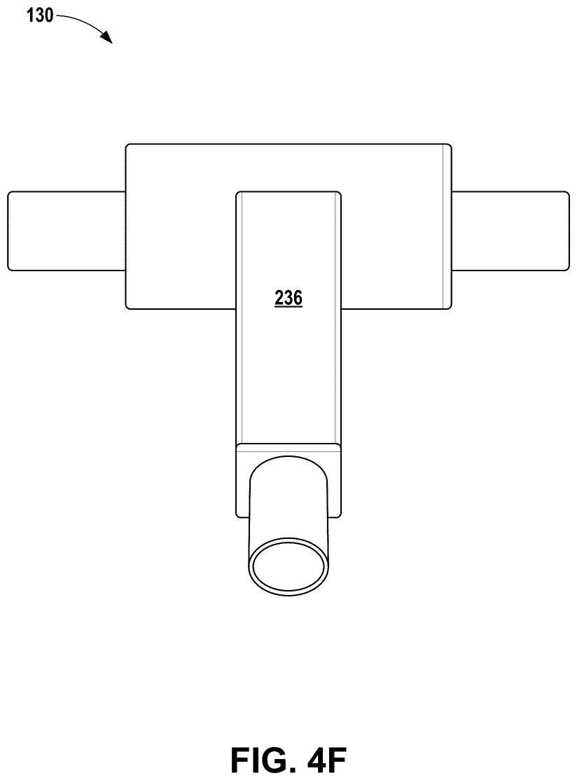

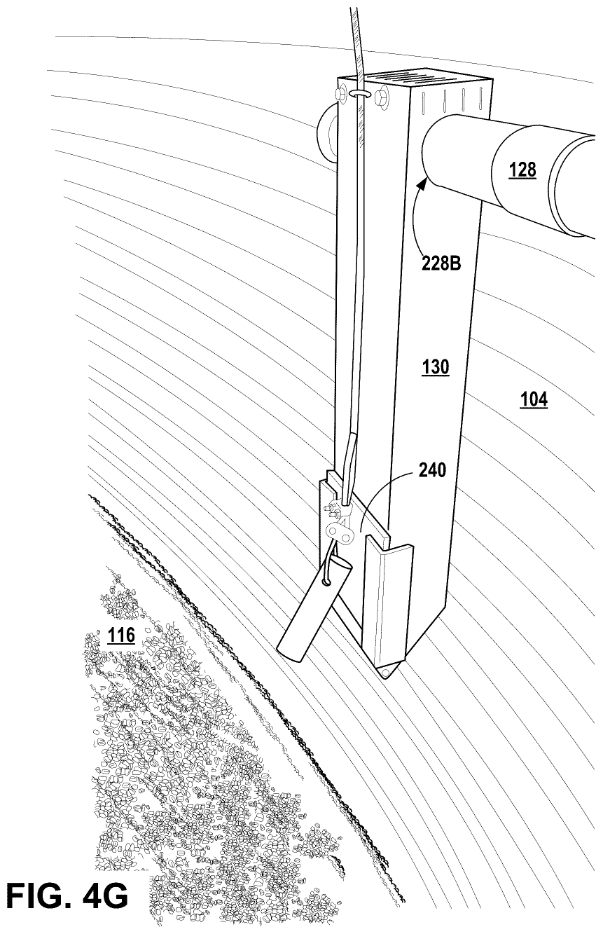

In one such example, collection box 130 and/or moisture tester 122 may be configured to automatically release the combined sample 230 into a conveniently removable receptacle after the moisture measurement is complete. In other examples, collection box 130 includes an openable door 240 that provides access to the combined sample 234, i.e., to manually discharge the sample 234 into a transportable receptacle. In the example shown in FIGS. 4A-4F, the door 240 is hingedly attached to a front side of the box 130 to provide access to the box's interior volume. In the example of FIGS. 4G & 4H, the door 240 is slidably attached to the front side of the box 130 to provide access to the combined grain sample 234.

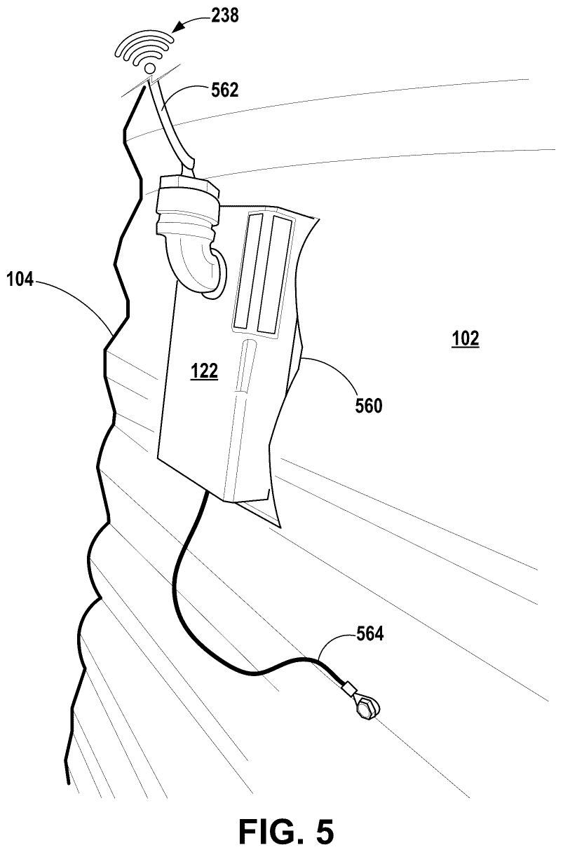

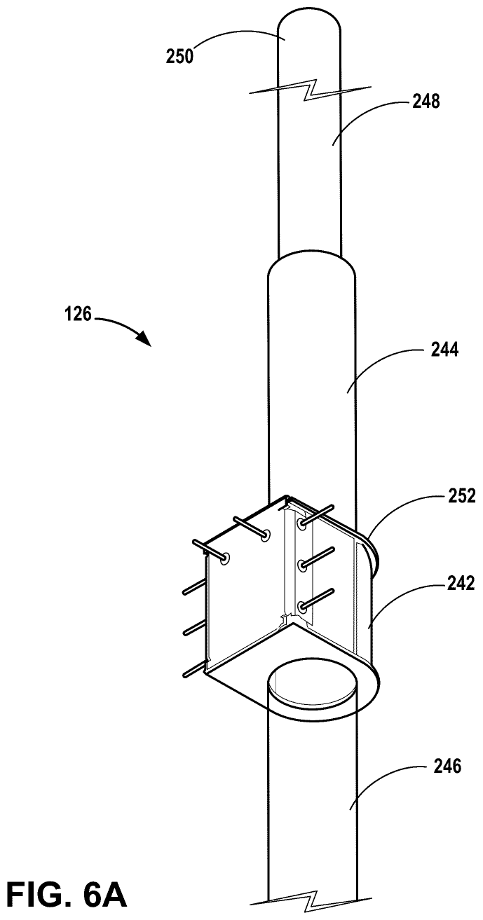

FIGS. 2B and 2D further illustrate two examples of a drop tube 126 (specifically, drop tubes 126A and 126F, respectively), and a closeup view of a drop tube 126 is shown in FIGS. 6A & 7A. In these examples, each drop tube 126 includes a one-way valve (or “check” valve) 242, and four other tubes: an upper tube 244; a curved lower tube 246; a valve-actuator tube 248, and a standpipe 250.

The check valve 242 is positioned between the upper tube 244 and the curved lower tube 246. As referenced above, each drop tube 126 is configured to continuously extract a “trickle” of grain, i.e., for an extended duration, while the dried grain 116 is being released through the dump chutes 112. Accordingly, the check valve 242 is configured to allow the partial grain sample 216 to fall only downward through the drop tube 126 into the connective tubing 128, while simultaneously preventing the partial grain sample 216 from being blown back upward into upper tube 244 once the air blower 126 is activated. More specifically, the one-way valves 242 collectively form a pressure seal within the connective tubing 128, without which, the air blower 124 could not build enough air pressure to propel the partial grain samples 216 distally through the connective tubing.

Check valve 242 can include any suitable “one-way” mechanism, including a ball valve, a sump pump, or the like. In the present examples, check valve 242 includes a spring-biased one-way flipper 252, an example of which is shown in FIG. 6B, 7B, and 7C. The flipper's spring-biased hinge allows the flipper to swing in only one direction (i.e., downward) to open the check valve 242. Specifically, the flipper 252 opens downward in response to applied pressure from the valve-actuator tube 248.

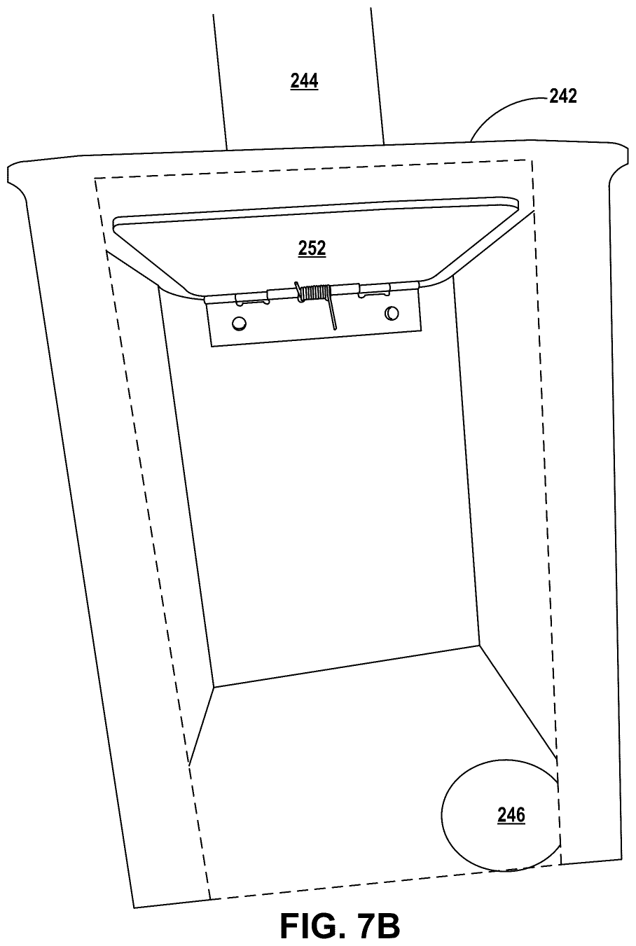

For instance, as further shown in the close-up view of FIG. 8, the valve-actuator tube 248 includes a top end 254A and a tapered (or “pointed”) bottom end 254B. The top end 254A of the valve-actuator tube 248 is configured to fixedly couple to the underside of a respective dump chute 112. When the dump chutes 112 drop downward to release the dried grain 116 into the storage bin 108, the attached valve-actuator tube 248 slides downward into the upper tube 244 to press downward on the flipper 252 to open the check valve 242. When the dump chutes 112 raise back upward, they pull the valve-actuator tubes 248 upward through the upper tubes 244, allowing the spring-biased flippers 252 to close the valves 242.

As further shown in FIGS. 2B and 2D, a lower portion 256 of the lower tube 246 of each drop tube 126 features a slight bend or curvature adjacent to where the lower tube 246 communicatively couples to connective tubing 128. The curvature of this lower portion 256 generally bends toward the direction of the air current 232 from the air blower 124. This curved portion 256 further ensures that partial grain samples 216 within the connective tubing 128 cannot be blown back upward into the drop tube 126, as such motion would directionally opposed to the flow of air 232.

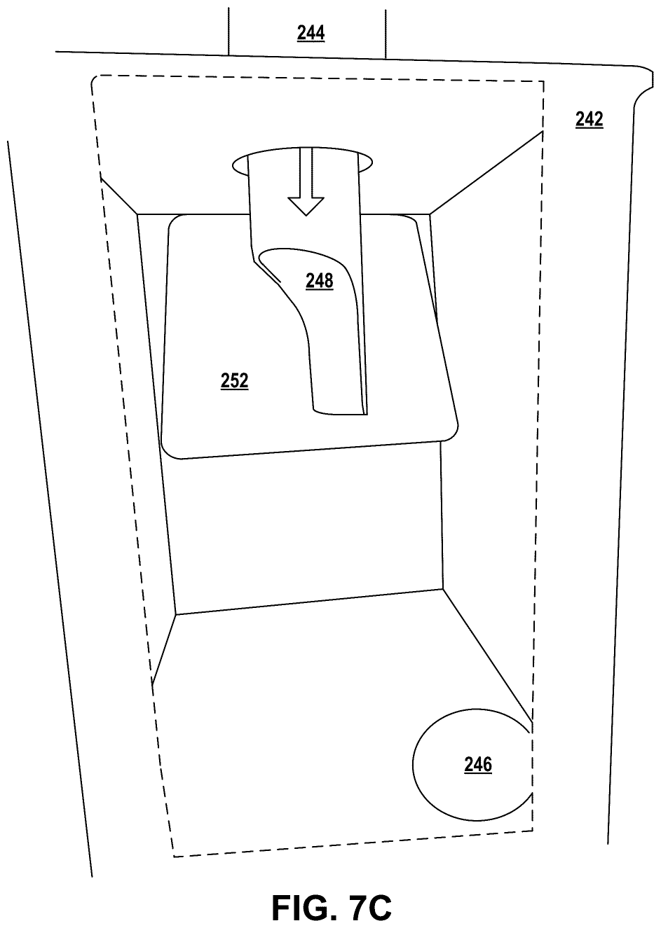

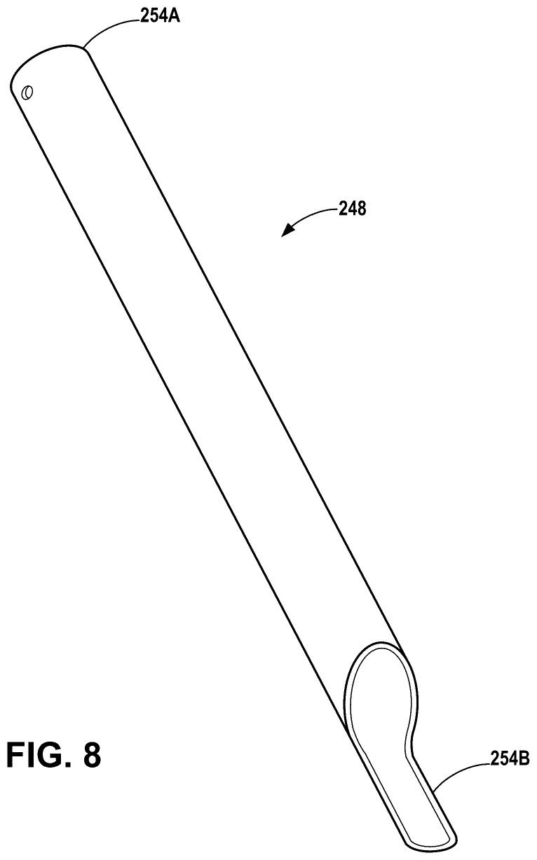

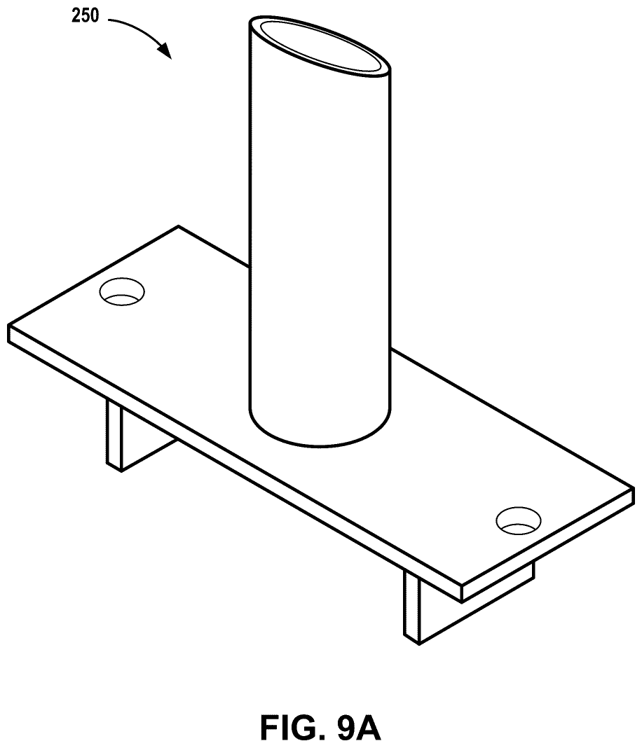

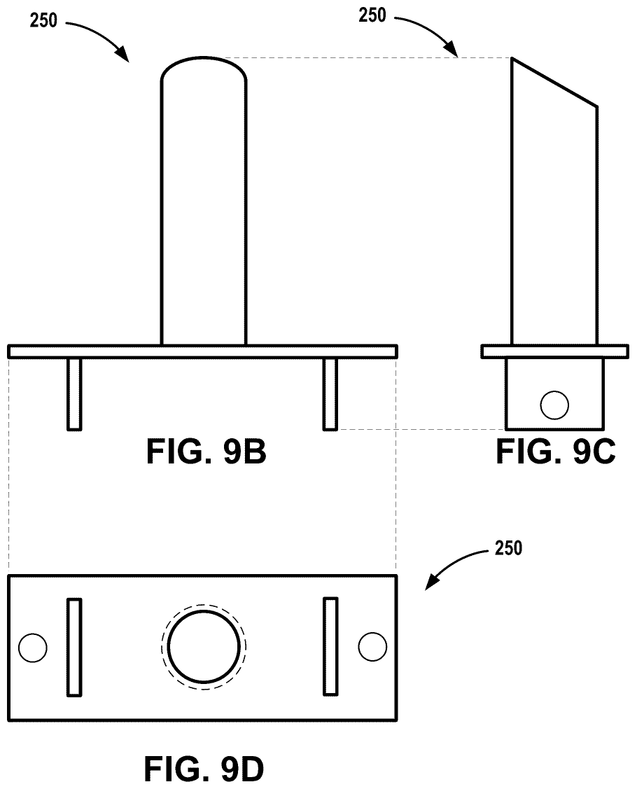

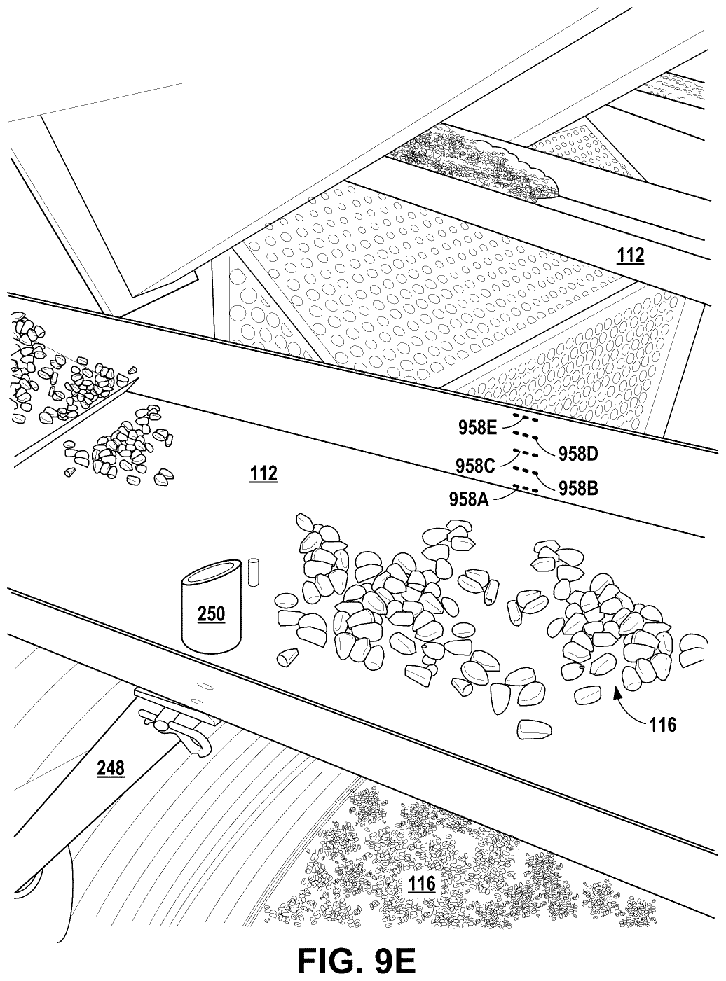

As further shown in FIGS. 2B and 2D, and in the close-up views of FIGS. 9A-9E, in some examples, each drop tube 126 includes a standpipe 250. The standpipe 250 is configured to extend upward through the corresponding dump chute 112 to help reduce yet another source of localized temperature bias among sampled kernels 216.

Specifically, dried grain 116 sliding down the dump chute 112 can temporarily fill the dump chute 112 up to various heights—for illustrative purposes only, six example heights 958A-958E are marked in FIG. 9E. In some cases, the temperature and moisture content of sampled kernels 116 can partially depend on the dump-chute height 958 from which the kernels 116 were sampled. For instance, kernels at the bottom-most height 958A—i.e., kernels lying directly upon the conductive metal surface of the dump chute 112—might, on-average, be incrementally warmer and dryer than other kernels stacked on top of them at heights 968B-958E.

Accordingly, standpipe 250 prevents the “biased” kernels 116 lying directly on the surface of dump chute 112 from falling into the drop tube 126. Instead, the partial grain sample 216 is collected from the more-representative kernels above.

FIG. 5 shows an example implementation of the moisture tester 122. In this example, the moisture tester 122 is mounted to the exterior housing 104 of the grain dryer 102. The exterior housing 104 defines an opening or aperture 560, through which moisture tester 122 is functionally coupled to the collection box 130 (not shown) to measure the moisture content of a grain sample 234 therein. The resulting moisture data is transmitted as an electrical signal 238 via a wired connection 562 to the temperature controller 120 to inform the controller 120 whether to adjust the next drying cycle by, for example: increasing or decreasing the predetermined duration of the drying cycle, increasing or decreasing the threshold temperature of the dump-chute thermometer 114, or, in rare examples, adjusting the plenum temperature of the heater 110. In other examples, the moisture tester 122 can be communicatively coupled to the temperature controller 120 via a wireless data connection, such as Wi-Fi, Bluetooth, or the like. The moisture tester 122 further includes a grounding wire 564 to electrically ground the moisture tester 122 to the housing 104 of the grain dryer 102.

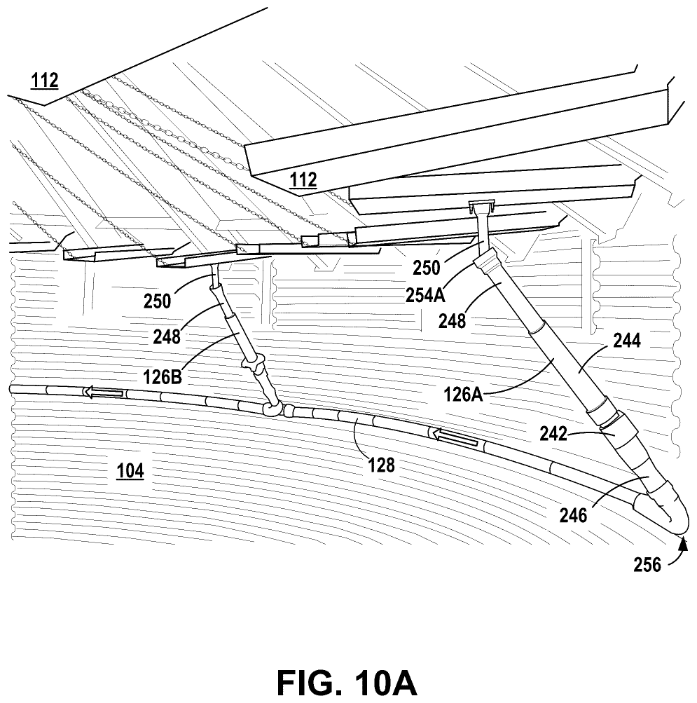

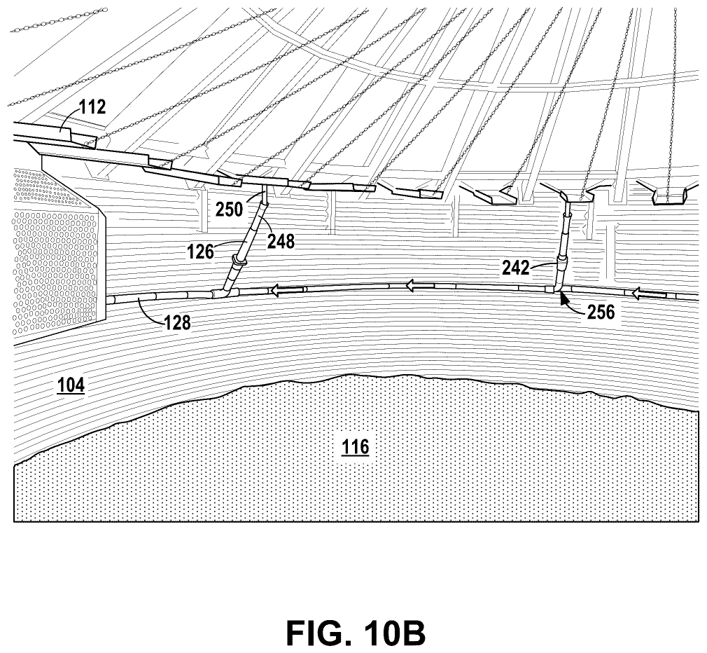

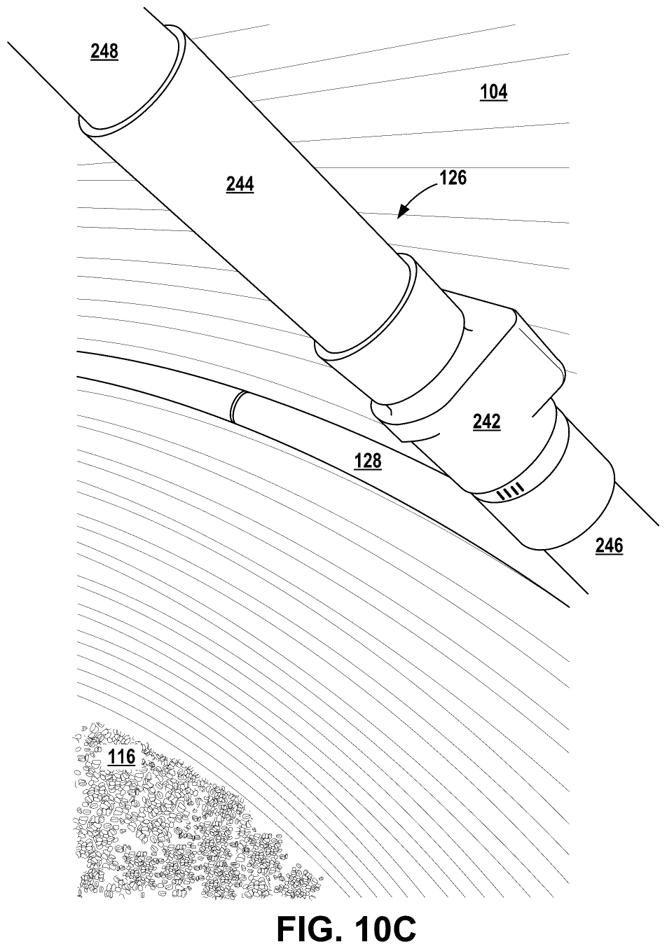

FIGS. 10A-10C show another example implementation of the dry-grain sample-collector system 100 installed within an industrial-sized grain dryer 102. In this example, a portion of the standpipe 250 extends downward through the dump chute 112, whereby the upper end 254A of the valve-actuator tube 248 is adhered to the bottom end of the standpipe 250. When the dump chutes 112 drop downward, the standpipe 250 pushes the valve-actuator tube 248 downward into the upper tube 244 of the drop tube 126, and pulls the valve-actuator tube 248 back out again when the dump chutes 112 are raised.

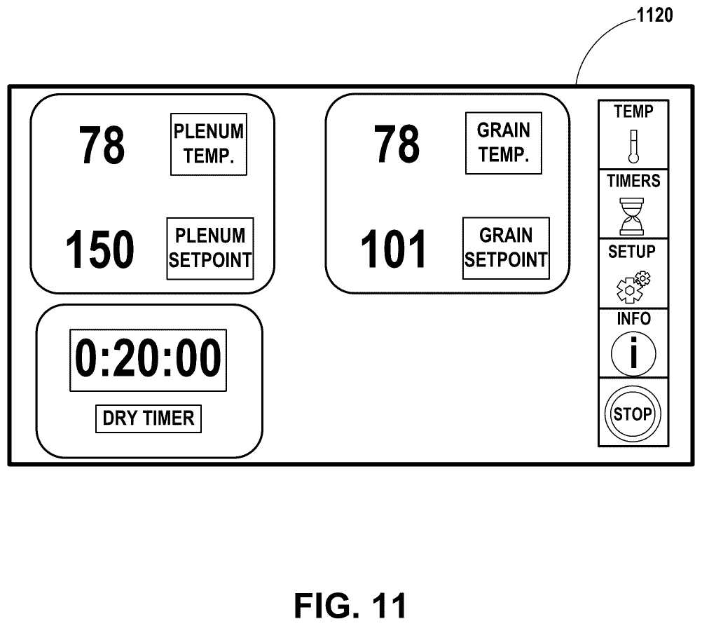

FIG. 11 shows an example control panel 1120 for the grain dryer's temperature controller 120 (FIGS. 1A-1C). The control panel 1120 can be or can include a digital screen or touchscreen configured to display a graphical user interface (GUI). Additionally or alternatively, the control panel 1120 can be or can include a mechanical user interface, e.g., having manual input buttons, switches, levers, dials, and the like. As shown, the control panel 1120 enables the user to manually adjust the rate-of-change of the feedback mechanism, that is, the ratio between the change in measured moisture content and the corresponding adjustment to the subsequent drying cycle.

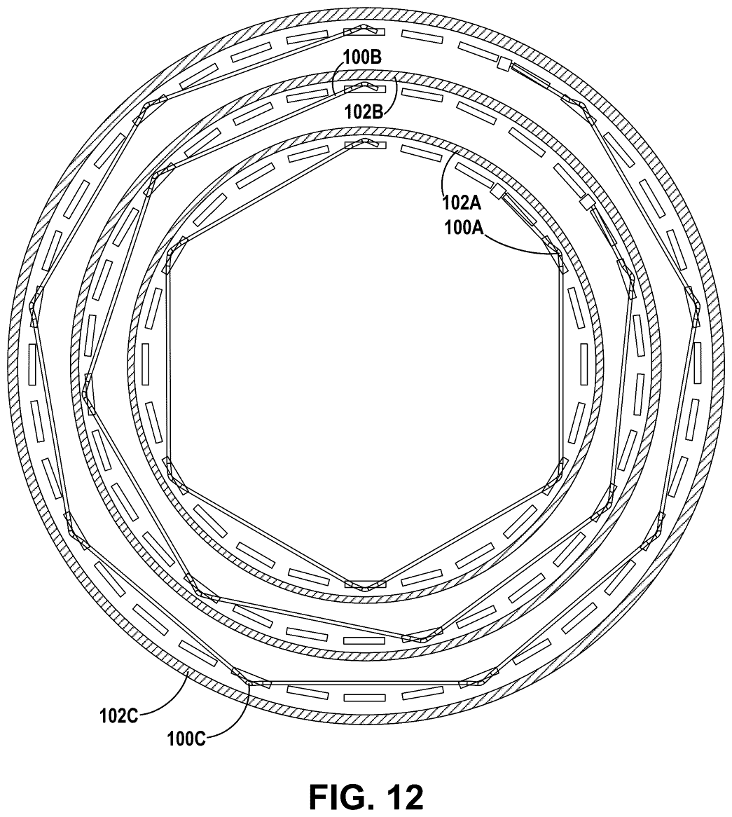

FIG. 12 is a conceptual diagram illustrating how sample-collection system 100 can be installed within various sizes of industrial grain dryers 102. As referenced throughout this disclosure, a first sampler system 100A can be installed in a first grain dryer 102A having a 24-foot diameter and 24 dump chutes 112. Sampler system 100A can include, in one non-limiting example, six drop tubes 126—i.e., ¼ the number of dump chutes 112. Similarly, a second sampler system 100B can be installed in a second grain dryer 102B having a 30-foot diameter and 30 dump chutes 112. Sampler system 100B can preferably include, in one non-limiting example, seven drop tubes 126 (as shown in FIG. 12), or eight drop tubes 126. Similarly, a third sampler system 100C can be installed in a third grain dryer 102C having a 36-foot diameter and 36 dump chutes 112. Sampler system 100C can preferably include, in one non-limiting example, nine drop tubes 126 (as shown in FIG. 12)—i.e., ¼ the number of dump chutes 112. In other examples, sample-collection systems 100A/B/C can include more drop tubes, fewer drop tubes, or a different arrangement of drop tubes, than those depicted in FIG. 12.

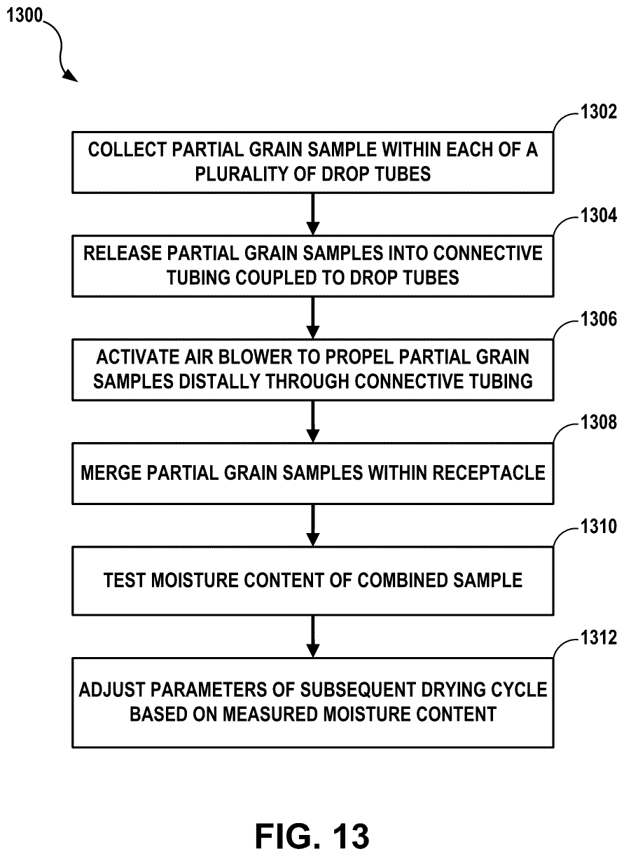

FIG. 13 is a flowchart 1300 illustrating an example technique for collecting a highly representative sample of dried grain from a roof-based industrial grain dryer. The sample-collection technique includes, at Step 1302, receiving a respective partial grain sample within each of a plurality of drop tubes connected to respective dump chutes of the grain dryer. In some such examples, Step 1302 includes using a valve-actuator tube coupled to each dump chute to open a a one-way check valve within each drop tube in order to receive the partial sample.

At Step 1304, the technique includes releasing the partial grain samples into a length of connective tubing coupled across the bottom ends of the plurality of drop tubes. In some such examples, the bottom ends of the drop tubes are curved to discourage the grain samples from travelling back upward into the drop tubes.

At Step 1306, the technique includes activating an air blower coupled to a proximal end of the length of connective tubing to propel the samples distally through the tubing, and into a collection receptacle at the distal end of the tubing, where, at Step 1308, the individual grain samples are merged into one combined sample.

At Step 1310, the technique further includes using a moisture tester to measure a residual moisture content of the combined sample of dried grain, whereby, at Step 1312, the measured moisture content is transmitted to a control system of the grain dryer to automatically adjust parameters of the subsequent drying cycle based on the current moisture content.

It should be understood that individual steps of the previous examples may be performed in any suitable order and/or simultaneously, as long as the overall system remains operable. Similarly, various aspects disclosed herein may be combined in different combinations than those explicitly presented in the description and accompanying drawings. Additionally, certain aspects of this disclosure described as being performed by a single module or unit (e.g., for clarity) may also be performed by a combination of units or modules.

What is claimed is:

1. A grain-sample-collection system for an industrial grain dryer, the system comprising:
a plurality of drop tubes each having a top end and a bottom end, wherein the top end of each drop tube is communicatively coupled to a respective dump chute of the industrial grain dryer and configured to receive a respective partial grain sample from the dump chute;
connective tubing communicatively coupling the bottom ends of the plurality of drop tubes;
an air blower communicatively coupled to a proximal end of the connective tubing, wherein the air blower is configured to propel the partial grain samples distally through the connective tubing; and
a collection box communicatively coupled to a distal end of the connective tubing, wherein the collection box is configured to receive and aggregate the partial grain samples into a combined sample for moisture testing.

2. The system of claim 1, further comprising an automatic moisture tester communicatively coupled to the collection box, wherein the moisture tester is configured to generate a moisture measurement indicative of a moisture content of the combined sample.

3. The system of claim 2, wherein the moisture tester is configured to transmit an indication of the moisture measurement to a temperature controller of the industrial grain dryer.

4. The system of claim 1, wherein the collection box comprises a quick-release mechanism configured to release the combined sample from the collection box for secondary moisture testing.

5. The system of claim 1, wherein each drop tube comprises a one-way check valve configured to enable the respective partial grain sample to pass downward through the check valve and to prevent the respective partial grain sample from returning upward through the check valve.

6. The system of claim 5, wherein the check valve comprises a spring-biased flipper.

7. The system of claim 6, wherein each drop tube comprises:
an upper tube coupled to an upper side of the check valve;
a lower tube coupled to a lower side of the check valve; and
a valve-actuator tube partially disposed within the upper tube, the valve-actuator tube having an upper end coupled to the respective dump chute and a tapered lower end configured to depress the spring-biased flipper to open the check valve.

8. The system of claim 1, wherein each drop tube comprises a standpipe configured to extend upward through a horizontal surface of the respective dump chute.

9. The system of claim 1, wherein each drop tube is configured to continuously collect the respective partial grain sample from the respective dump chute throughout a predetermined duration during which the dump chutes are lowered to release a flow of dried grain downward into a storage bin of the industrial grain dryer.

10. The system of claim 1, wherein the industrial grain dryer comprises 24 dump chutes, and wherein the plurality of drop tubes comprises 6 drop tubes.

11. The system of claim 1, wherein the industrial grain dryer comprises 30 dump chutes, and wherein the plurality of drop tubes comprises 7 drop tubes or 8 drop tubes.

12. The system of claim 1, wherein the industrial grain dryer comprises 36 dump chutes, and wherein the plurality of drop tubes comprises 9 drop tubes.

13. The system of claim 1, wherein the drop tubes are coupled to the respective dump chutes such that the drop tubes are evenly spaced around an inner circumference of the industrial grain dryer.

14. The system of claim 1, wherein a lower portion of each drop tube is curved toward a flow direction of a flow of air through the connective tubing from the air blower.

15. A method comprising:
receiving, by each of a plurality of drop tubes coupled to respective dump chutes of a roof-based industrial grain dryer, a respective partial grain sample;
propelling, by an air blower, the partial grain samples distally through connective tubing coupled across bottom ends of the plurality of drop tubes; and
receiving, by a collection box, the partial grain samples to form a combined sample for moisture testing.

16. The method of claim 15, further comprising:
measuring, by a moisture tester coupled to the collection box, a moisture content of the combined sample; and
transmitting, by the moisture tester, an indication of the moisture content to a temperature controller of the industrial grain dryer.

17. The method of claim 15, wherein receiving the respective grain sample comprises:
responsive to a lowering of the respective dump chute, opening, by each of the plurality of drop tubes, a respective one-way check valve disposed within the drop tube.

18. The method of claim 17, wherein opening the one-way check valve comprises:
internally receiving, by each of the plurality of drop tubes, a tapered lower end of a respective valve-actuator tube coupled to the respective dump chute, such that the tapered lower end depresses a spring-biased flipper of the one-way check valve.

19. A roof-based industrial grain dryer comprising:
a cylindrical storage bin having a circular cross-section;
a plurality of dump chutes spaced evenly around a circumference of the circular cross-section, wherein each of the plurality of dump chutes is configured to periodically lower to direct a flow of dried grain downward into the storage bin;
a plurality of drop tubes each having a top end and a bottom end, wherein the top end of each drop tube is communicatively coupled to a respective one of the plurality of dump chutes, and wherein each drop tube is configured to collect a respective partial grain sample from the flow of dried grain directed by the dump chute;
connective tubing communicatively coupling the bottom ends of the plurality of drop tubes;
an air blower communicatively coupled to a proximal end of the connective tubing, wherein the air blower is configured to propel the partial grain samples distally through the connective tubing; and
a collection box communicatively coupled to a distal end of the connective tubing, wherein the receptacle is configured to receive and aggregate the partial grain samples into a combined sample for moisture testing.

20. The roof-dry grain dryer of claim 19, further comprising:
a heater configured to dehydrate a supply of moist grain;
a moisture tester configured to measure a moisture content of the combined sample; and
a temperature controller configured to:
receive an indication of the moisture content from the moisture tester; and
adjust an operating duration of the heater for a subsequent drying cycle based on the indication of the moisture content of the combined sample.
